(19) United States
(12) Patent Application Publication
(10) Pub. No.: US 2010/0248077 A1
(43) Pub. Date: Sep. 30, 2010

(54) CATALYST INK, METHOD FOR PREPARING THE SAME, METHOD FOR STORING THE SAME, AND FUEL CELL

(75) Inventors: Shino Matsumi, Tsukuba-shi (JP); Hiroyuku Kurita, Tsukuba-shi (JP); Shi Saito, Tsukuba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Chuo-ku, Tokyo (JP)

(21) Appl. No.: 12/743,313

(22) PCT Filed: Nov. 17, 2008
(86) PCT No.: PCT/JP2008/071184

§ 371 Date: May 17, 2010

(30) Foreign Application Priority Data
Nov. 19, 2007 (JP) 2007-298957

(51) Int. Cl. B01J 31/04; H01M 8/10

(52) U.S. Cl. 429/492; 502/172

(57) ABSTRACT

A catalyst ink for preparing a catalyst layer of a solid polymer electrolyte fuel cell, wherein the ratio of the sum of the weights of an organic aldehyde and an organic carboxylic acid relative to the total weight of the catalyst ink is 0.20% by weight or less.

### TECHNICAL FIELD

The present invention relates to a catalyst ink which is used for the preparation of a catalyst layer of a solid polymer electrolyte fuel cell, a method for preparing the same, a method for storing the same, and a solid polymer electrolyte fuel cell formed using the catalyst ink.

### BACKGROUND ART

Recently, a solid polymer electrolyte fuel cell (hereinafter referred to as a “fuel cell”) is expected to be put to practical use as an electricity generator in housing applications or automotive applications. In a fuel cell, electrodes referred to as a catalyst layer containing a catalyst material (platinum or the like) for promoting a redox reaction of hydrogen and air are formed on both sides of an ion-conductive membrane (polymer electrolyte membrane) taking a role of ion conduction, and further a gas diffusion layer for efficiently delivering a gas to the outside of the catalyst layer is combined therewith. Here, one in which the catalyst layer is formed on both sides of the polymer electrolyte membrane is usually called as a membrane-electrode assembly (hereinafter referred to as an “MEA”).

Such an MEA is prepared by using (1) a method in which a catalyst layer is directly formed on a polymer electrolyte membrane, (2) a method in which a catalyst layer is formed on a substrate to be a gas diffusion layer, such as carbon paper or the like, and then the catalyst layer is assembled with a polymer electrolyte membrane, (3) a method in which a catalyst layer is formed on a supporting substrate, the catalyst layer is transferred to a polymer electrolyte membrane, and then the supporting substrate is peeled off, or other methods. Among these, the method of (3) is a method which has been hitherto particularly widely used (for example, see JP-H10-64574-A).

In any method for the preparation of the MEA of the above (1) to (3), when a catalyst layer is formed, a liquid composition containing at least a catalyst material and a solvent in which the catalyst material is dispersed in the solvent by ultrasonic treatment or the like (hereinafter referred to as a “catalyst ink” that is widely used in the art) is used. Specifically, a catalyst ink is used in the step of directly coating a catalyst ink onto a polymer electrolyte membrane in the method of (1), in the step of coating a catalyst ink onto a substrate to be a gas diffusion layer in the method of (2), and in the step of coating a catalyst ink onto a supporting substrate in the method of (3).

Incidentally, in order to enhance the electricity generation characteristics of the fuel cell, it is necessary to make an electrochemical reaction (catalyst reaction) relevant to the catalyst material in the catalyst layer of the MEA smoothly proceed. From this viewpoint, attempts have been often made to inhibit the poisoning of the catalyst material (catalyst poisoning). For example, development of a catalyst material in which the catalyst poisoning hardly occurs, reduction in the catalyst poisoning by a technique for improving a fuel gas supplied to a catalyst layer, or the like have been investigated (for example, see JP-2003-36859-A and JP-2003-168455-A).

Until now, the technologies in which any of the means for inhibiting the catalyst poisoning is intended to inhibit the catalyst poisoning occurring over time in the course of the use of a fuel cell have been mainly investigated, and a technology in which the catalyst poisoning occurs in a step of preparing the MEA has not been substantially investigated. In addition, in a technology in which the catalyst poisoning is inhibited by the components of the MEA, a component other than the catalyst material has not been substantially investigated.

### DISCLOSURE OF INVENTION

Thus, it is an object of the present invention to provide a catalyst ink which is capable of sufficiently inhibiting the catalyst poisoning occurring over time as well as the catalyst poisoning occurring at a step of preparing the catalyst layer, a method for preparing the same, and a method for storing the same, and further provide an MEA and a fuel cell, each having high electricity generation characteristics formed using the catalyst ink.

That is, the present invention provides the following inventions.

[1] A catalyst ink for preparing a catalyst layer of a solid polymer electrolyte fuel cell, wherein the ratio of the sum of the weights of an organic aldehyde and an organic carboxylic acid relative to the total weight of the catalyst ink is 0.20% by weight or less.

[2] The catalyst ink according to [1] which contains water as a solvent.

[3] The catalyst ink according to [1] or [2] which contains a primary alcohol as a solvent.

[4] The catalyst ink according to [2] or [3], wherein the ratio of the sum of the weights of a primary alcohol and/or the water relative to the total weight of the solvent constituting the catalyst ink is 90.0% by weight or more.

[5] The catalyst ink according to any one of [3] to [4], wherein the primary alcohol is an alcohol having 1 to 5 carbon atoms.

[6] The catalyst ink according to any one of [1] to [5], wherein the organic carboxylic acid or the organic aldehyde is a compound which vaporizes under 101.3 kPa at 300° C. or lower.

[7] A method for preparing the catalyst ink according to any one of [1] to [6], the method comprising a step of bringing a catalyst material and a solvent into contact with each other under an inert gas atmosphere having an oxygen concentration of 1% by volume or less.

[8] A method for storing the catalyst ink according to any one of [1] to [6], wherein the catalyst ink is stored under an inert gas atmosphere having an oxygen concentration of 1% by volume or less.

[9] A catalyst layer prepared using the catalyst ink according to any one of [1] to [6].

[10] A membrane-electrode assembly comprising the catalyst layer according to [9].

[11] A solid polymer electrolyte fuel cell comprising the membrane-electrode assembly according to [10].

### BRIEF DESCRIPTION OF DRAWINGS

FIG. 1 is a schematic view showing the cross-section constitution of a fuel cell according to the preferred embodiment.

### EXPLANATION OF REFERENCE

10 Fuel cell
12 Ion-conductive membrane
14a, 14b Catalyst layers
16a, 16b Gas diffusion layers
18a, 18b Separators
20 MEA (membrane-electrode assembly)

### BEST MODE FOR CARRYING OUT THE INVENTION

Hereinbelow, the preferred embodiments of the present invention will be described in detail, but the present invention is not intended to be limited to the embodiments below.

<Catalyst Ink>

The catalyst ink of the present invention contains a catalyst material and a solvent. The catalyst ink of the present invention contains a polymer electrolyte, if necessary, and the catalyst ink has a ratio of the sum of the weights (hereinafter also referred to as a weight content) of an organic aldehyde and an organic carboxylic acid (hereinafter the organic aldehyde and the organic carboxylic acid are also collectively referred to as an “organic carbonyl compound”) of 0.20% by weight or less, relative to the total weight. The weight content of the organic carbonyl compounds in the catalyst ink is more preferably 0.15% by weight or less, and particularly preferably 0.10% by weight or less.

Here, the organic carboxylic acid is a compound having carboxyl group (—COOH) in the molecule, and it typically means that carboxyl group is bonded to a hydrocarbon residue. Further, this carboxyl group may form a salt with a metal ion or an ammonium ion.

Furthermore, the organic aldehyde refers to a compound having aldehyde group (—CHO) in the molecule, and it typically means that aldehyde group is bonded to a hydrocarbon residue. As described later, it may be a compound having an acetal group or a hemiacetal group, which can be easily converted into the aldehyde group by a heating treatment or the like relevant to the preparation step of MEA, or a compound which can be subjected to depolymerization to produce the organic aldehyde. In addition, when such a compound which can produce the organic aldehyde (organic aldehyde precursor) is contained in the catalyst layer, the weight content is determined from the weight after the organic aldehyde precursor is changed into the organic aldehyde.

The present inventors have found that such an organic carbonyl compound easily subjects a catalyst material to poisoning, and an MEA including a catalyst layer in which the organic carbonyl compound remains has a damaged catalytic capability originally contained by the catalyst material from immediately after the preparation thereof. Further, they have consequently found that the catalyst ink having a sum of the weight contents of the organic carbonyl compounds in the above-described range is capable of sufficiently inhibiting the poisoning of the catalyst material contained in the catalyst layer prepared using the catalyst ink (catalyst poisoning), and thus efficiently exerting the catalytic capability originally contained by the catalyst material. Moreover, an MEA including a catalyst layer which reduces the weight content of such an organic carbonyl compounds is expected to inhibit a decline of the catalytic capability of the catalyst material damaged immediately after the preparation of the MEA, and also decline of the catalytic capability of the catalyst material by using a fuel cell using the MEA over time.

Furthermore, the present inventors have further studied, and as a result, it has been proven that among the organic carbonyl compounds, an organic carbonyl compound which vaporizes under 101.3 kPa (1 atm) at 300° C. or lower, particularly has a tendency to easily cause catalyst poisoning of a catalyst material. Accordingly, a catalyst ink having a reduction in such an organic carbonyl compound is particularly preferable in terms of accomplishing the purposes of the present invention. In addition, an organic carbonyl compound which vaporizes at a temperature of 300° C. or lower encompasses a compound capable of being changed into an organic carbonyl compound which vaporizes under 101.3 kPa at 300° C. or lower.

As such, the lower temperature at which the organic carbonyl compound vaporizes, the more inconveniences that the organic carbonyl compound is diffused into the catalyst layer by vaporization or the like, and thus causes poisoning of a wide range of catalyst materials in the catalyst layer to occur when the catalyst layer is warmed by the operation of the fuel cell. In order to avoid the inconveniences, for the catalyst ink, it is preferable to reduce the weight content of the organic carbonyl compound which vaporizes at 300° C. or lower, and it is more preferable to reduce the weight content of the organic carbonyl compound which vaporizes at 200° C. or lower.

Hereinbelow, the organic carbonyl compound will be described in detail.

Examples of the organic carboxylic acid include organic carboxylic acids having 1 to 5 carbon atoms such as formic acid, acetic acid, propionic acid, butyric acid, pivalic acid, valeric acid, isovaleric acid, or the like since the catalyst poisoning more easily occurs, and it is preferable to reduce such organic carboxylic acids. Further, as described above, theses organic carboxylic acids also include those which form salts with metal ions or the like.

On the other hand, examples of the organic aldehyde include organic aldehydes having 1 to 5 carbon atoms, such as formaldehyde, acetaldehyde, propionaldehyde, butylaldehyde, isobutylaldehyde, pivalaldehyde, valeraldehyde, isovaleraldehyde, or the like since the catalyst poisoning more easily occurs, and it is preferable to reduce these organic aldehydes. Further, as described above, these organic aldehydes also include those in which an aldehyde group is reacted with a suitable alcohol to be converted into an acetal group or a hemiacetal group.

The catalyst ink of the present invention contains a solvent.

The solvent is not particularly limited as long as it can disperse catalyst materials by a known method such as ultrasonic treatment or the like with the exception of an organic carbonyl compound.

The catalyst ink of the present invention preferably contains water as the solvent. Water is preferably used since it does not substantially cause catalyst poisoning of the catalyst material to occur in the catalyst ink and the risk of firing is reduced.

Furthermore, as a solvent used for the catalyst ink of the present invention, a primary alcohol is preferably contained since catalyst materials such as platinum or the like on particles are inhibited from aggregation and that a catalyst layer is easily formed since the boiling point is relatively low. On the contrary, the primary alcohol has a problem that it is easily changed into an organic carbonyl compound by the action of a catalyst material, but by the method for preparing the catalyst ink of the present invention as described later, the conversion of the primary alcohol to an organic carbonyl compound is well inhibited, and thus the production of an organic carbonyl compound causing catalyst poisoning to occur can be inhibited. Further, by the method for storing the catalyst ink of the present invention as described later, the production of an organic carbonyl compound generated over time is well inhibited, and thus the deterioration of the catalyst ink over time can also be prevented. In addition, as the primary alcohol, an alcohol having 1 to 5 carbon atoms is preferred since it is easily removed upon preparation of the catalyst, and when water, which is preferred as a solvent used for the catalyst ink, is used in combination, an alcohol having 1 to 4 carbon atoms is more preferred in terms of miscibility with water. Specific examples of the preferable primary alcohol include methanol, ethanol, 1-propanol, 1-butanol, 1-pentanol, ethylene glycol, diethylene glycol, and glycerin.

Furthermore, when water and a primary alcohol are mixed and used as a solvent for the catalyst ink of the present invention, the content ratio of water relative to the total weight of the solvent is preferably 5% by weight or more in terms of the improved stability upon preparation of the catalyst ink. More specifically, the content ratio of water relative to the total weight of the solvent is preferably from 5 to 95% by weight, and more preferably from 10 to 90% by weight. On the other hand, the content ratio of the primary alcohol relative to the total weight of the solvent is preferably 5% by weight or more in terms of aggregation of the catalyst materials is sufficiently inhibited as described above, and more specifically, the content ratio of the primary alcohol relative to the total weight of the solvent is preferably from 5 to 95% by weight, and more preferably from 10 to 90% by weight.

Moreover, the solvent used for the catalyst ink of the present invention may contain a tertiary alcohol. The tertiary alcohol is advantageous in that it is hard to produce an organic carbonyl compound causing catalyst poisoning to occur.

The tertiary alcohol is typically a compound represented by the following chemical formula (I):

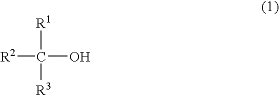

wherein, R¹, R², and R³ each independently represents an alkyl group having 1 to 3 carbon atoms, or a halogenated alkyl group in which a hydrogen atom of a part of the alkyl group is substituted with a halogen atom. In addition, the alkyl group having 3 carbon atoms or the halogenated alkyl group having 3 carbon atoms may be linear chained or branch chained. In R¹, R², and R³, the sum of the numbers of the carbon atoms is preferably 8 or less. The sum of the carbon atoms can be chosen by taking into consideration of the boiling point of the tertiary alcohol. The boiling point of the tertiary alcohol at 101.3 kPa (1 atm) is preferably 50° C. or higher and 200° C. or lower, and more preferably 50° C. or higher and 150° C. or lower. The tertiary alcohol having a boiling point in this range is relatively easily removed, and has an advantage that it hardly remains in the catalyst layer.

Specifically, examples of the preferable tertiary alcohol include t-butyl alcohol, 1,1-dimethylpropyl alcohol, 1,1-dimethylbutyl alcohol, 1,1,2-trimethylpropyl alcohol, 1-methyl-1-ethylpropyl alcohol, or the like.

Furthermore, as described above, a tertiary alcohol having a halogenated alkyl group may be used, but a tertiary alcohol having no halogenated alkyl group in the molecule is preferable in consideration of the environment.

The catalyst ink of the present invention preferably contains water and/or a primary alcohol as a solvent as described above, and as other solvents, for example, a tertiary alcohol or the like can be contained therein. In addition, when the solvent contains a tertiary alcohol, the amount of water or the primary alcohol, which is preferably the solvent to be used, is preferably 5% by weight or more, and more preferably 10% by weight or more, as expressed in the ratio of the sum of the weights of water and the primary alcohol relative to the total weight of the solvents for the catalyst ink.

The catalyst ink of the present invention contains catalyst materials.

Examples of the catalyst material contained in the catalyst ink include known catalyst materials used in a catalyst layer for a fuel cell. Examples thereof include platinum, or an alloy containing platinum (a platinum-ruthenium alloy, a platinum-cobalt alloy, or the like), a complex electrode catalyst (those as described, for example, in “Fuel Cell and Polymer” edited by The Society of Polymer Science, Japan Fuel Cell Material Conference, pp. 103 to 112, published by Kyoritsu Shuppan Co., Ltd., published on Nov. 10, 2005), or the like. Further, the catalyst material may be in a catalyst-supported form obtained by supporting the catalyst material on the surface of a carrier in order to facilitate the transportation of an electron in the catalyst layer. It is preferable that the carrier is mainly composed of an electrically conductive material. Examples of the electrically conductive material include electrically conductive carbon materials such as carbon black, a carbon nanotube, or the like, and ceramic materials such as titanium oxide or the like.

The catalyst ink preferably contains a polymer electrolyte. The polymer electrolyte takes a role of ion conduction.

If a component taking a role of ion conductivity is contained as a component constituting the catalyst layer, the catalyst reaction proceeds more efficiently, and accordingly, the electricity generation performance of the fuel cell can be further improved.

Among these, in terms of exhibiting a catalyst reaction with higher efficiency, a polymer electrolyte having a strong acidic group is preferred. Here, the strong acidic group is an acidic group having an acid dissociation constant pKa that is 2 or less, and specific examples thereof include sulfonic acid group (—SO₃H) and sulfonimide group (—SO₂NHSO₂—). Further, those having a super strong acidic group which further enhances the acidity of the strong acidic group by an electrophilic effect of fluorine atoms or the like are available. Examples of the super strong acidic group include —Rf¹—SO₃H (wherein Rf¹ represents an alkylene group in which part or all of the hydrogen atoms are substituted with a fluorine atom, or an arylene group in which part or all of the hydrogen atoms are substituted with a fluorine atom), and —SO₂NHSO₂—Rf² (wherein Rf² represents an alkyl group in which part or all of the hydrogen atoms are substituted with a fluorine atom, or an aryl group in which part or all of the hydrogen atoms is substituted with a fluorine atom). Among these strong acidic groups or super strong acidic groups, sulfonic acid group is particularly preferred.

Moreover, the polymer electrolyte having such a preferable ion-exchange group has a binding function allowing the strong adhesion of the above-described catalyst material, and as a result, the mechanical strength of the resulting catalyst layer is further enhanced.

Specific examples of the polymer electrolyte include the polymer electrolytes represented by (A) to (F) as described below.

(A) a polymer electrolyte in which the main chain of the polymer is made of aliphatic hydrocarbon, and sulfonic acid group is introduced thereinto,

(B) a polymer electrolyte in which the main chain of the polymer is made of aliphatic hydrocarbon and at least part of the hydrogen atoms of the main chain is substituted with a fluorine atom, and sulfonic acid group is introduced thereinto,

(C) a polymer electrolyte in which the main chain of the polymer has an aromatic ring, and sulfonic acid group is introduced thereinto,

(D) a polymer electrolyte in which the main chain contains an inorganic unit structure such as siloxane group, phosphagen group, or the like, and sulfonic acid group is introduced thereinto,

(E) a polymer electrolyte in which the copolymer having a combination of at least two kinds of the repeating units constituting the main chain of the polymers of (A) to (D), and sulfonic acid group is introduced thereinto,

(F) a polymer electrolyte in which the main chain or the side chain of the hydrocarbon polymer containing a nitrogen atom, an acidic compound such as sulfuric acid, phosphoric acid, or the like is introduced by ion bonding thereinto.

More specifically, the polymer electrolytes represented by the above (A) to (F) may also be mentioned as example.

Examples of the polymer electrolyte of the above (A) include polyvinyl sulfonic acid, polystyrene sulfonic acid, and poly(α-methyl styrene) sulfonic acid.

Examples of the polymer electrolyte of the above (B) include Nafion (registered trademark, manufactured by Dupont), Aciplex (registered trademark, manufactured by Asahi Kasei Corporation), Flemion (registered trademark, manufactured by Asahi Glass Co., Ltd.), or the like. Also, examples thereof include a sulfonic acid-type polystyrene-graft-ethylene-tetrafluoroethylene copolymer (ETFE) constituted of a main chain formed by copolymerization of a fluorocarbon vinyl monomer and a hydrocarbon vinyl monomer and a hydrocarbon side chain having sulfonic acid group as described in JP-H9-102322-A, and a sulfonic acid-type poly(trifluorostyrene)-graft-ETFE in which α,β,β-trifluorostyrene is graft-polymerized to a copolymer formed by copolymerization of a fluorocarbon vinyl monomer and a hydrocarbon vinyl monomer, and then sulfonic acid group is introduced thereinto as described in U.S. Pat. No. 4,012,303 or U.S. Pat. No. 4,605,685 are also included.

The polymer electrolyte of the above (C) may be one in which the main chain contains a hetero atom such as an oxygen atom or the like. Examples thereof include those obtained by introducing sulfonic acid group into a homopolymer such as polyether ketone, polyether ether ketone, polysulfone, polyether sulfone, polyether ether sulfone, poly(arylene ether), polyimide, poly((4-phenoxybenzoyl)-1,4-phenylene), polyphenylenesulfide, polyphenylquinoxalene, or the like. Specific examples thereof include sulfoarylated polybenzimidazole, sulfoalkylated polybenzimidazole (for example, see JP-H9-110982-A), or the like.

Examples of the polymer electrolyte of the above (D) include those in which sulfonic acid group is introduced into polyphosphazene, or the like, which may be easily prepared in accordance with Polymer Prep., 41, No. 1, 70 (2000).

The polymer electrolyte of the above (E) may be any one of those obtained by introducing sulfonic acid group into a random copolymer, those obtained by introducing sulfonic acid group into an alternating copolymer and those obtained by introducing sulfonic acid group into a block copolymer. Examples of obtained by introducing sulfonic acid group into a random copolymer include sulfonated polyether sulfonated polyether sulfone polymers as described in JP-H11-116679-A. Further, examples of those in which sulfonic acid group is introduced into a block copolymer include a block copolymer having a block containing sulfonic acid group as described in JP-2001-250567-A.

Examples of the polymer electrolyte of the above (F) include polybenzimidazole containing phosphoric acid as described in Japanese Patent Application National Publication No. H11-503262.

As such a polymer electrolyte, any one of the fluorine polymer electrolyte and the hydrocarbon polymer electrolyte may be used.

The above-described fluorine polymer electrolyte (B) is preferred since it is easily available since there are a variety of commercially available products.

On the other hand, it is preferable to use the hydrocarbon polymer electrolyte represented by (A), (C), (D), (E), or (F) among the above-described polymer electrolytes, in terms of easy recycling as well as high efficiency of the above reaction in the catalyst layer. In addition, the hydrocarbon polymer electrolyte means a polymer electrolyte in which the amount of halogen atoms contained in the polymer electrolyte is 15% by weight or less based on the total weight of the polymer electrolyte. Further, as described later, when an aromatic polymer electrolyte membrane having excellent electricity generation performance as a polymer electrolyte membrane (ion-conductive membrane) as well as durability is used in the preparation of a membrane-electrode assembly having more excellent characteristics, the polymer electrolyte used for the catalyst layer is preferably the above (E). Accordingly, the adhesiveness between the polymer electrolyte membrane and the catalyst layer tends to be better, and as a result, the electricity generation performance is enhanced. Among these, in order to attain compatibility between the high electricity generation performance and durability, the block copolymer composed of a segment having no ion-exchange groups, such as sulfonic acid group or the like, and a segment having sulfonic acid group is preferred among the above (E).

The above-described polymer electrolyte usually preferably has a molecular weight as expressed in a polystyrene-equivalent weight average molecule weight by means of gel permeation chromatography (hereinafter referred to as a “GPC method”) of from 1000 to 2000000, more preferably from 5000 to 1600000, and even more preferably 10000 or more and 1000000 or less.

If the weight average molecular weight is in the above-mentioned range, the mechanical strength of the catalyst layer preferably becomes better.

Furthermore, the ion-exchange capacity (IEC) of the polymer electrolyte is preferably from 0.8 to 6.0 meq/g, more preferably from 1.0 to 4.5 meq/g, and even more preferably from 1.2 to 3.0 meq/g. If the IEC is within this range, a catalyst layer having an excellent electricity generation performance as well as extremely excellent water resistance can be obtained.

Examples of the method for obtaining the polymer electrolyte of the above-described preferable IEC include (a) a method in which a polymer having a site to which an ion-exchange group can be introduced is prepared in advance, and an ion-exchange group is then introduced to the polymer, thereby preparing the polymer electrolyte, and (b) a method in which a compound having an ion-exchange group is used as a monomer and the monomer is subjected to polymerization, thereby preparing the polymer electrolyte. In order to obtain a polymer electrolyte of a specific IEC by using such a preparation method, (a) can be easily carried out by controlling mainly the ratio of the reactants to be used for introducing an ion-exchange group into the polymer. In (b), the control can be easily made from the molar weight of the repeating structural units of the polymer electrolyte induced by the monomers having an ion-exchange group and from the number of the ion-exchange groups. Alternatively, when copolymerization is carried out by using comonomers having no ion-exchange groups in combination, the repeating structural units having no ion-exchange groups and the repeating structural units having an ion-exchange group, and the copolymerization ratios thereof can be considered to control the IEC.

<Method for Preparing Catalyst Ink>

The catalyst ink of the present invention can be obtained, for example, by mixing the above-described catalyst material, a solvent including a primary alcohol and/or water, and the above-described polymer electrolyte. This catalyst material is usually dispersed in the solvent for the catalyst ink. On the other hand, the polymer electrolyte may be dissolved in the solvent or may be dispersed in the solvent. In addition, when a hydrocarbon polymer electrolyte is used as the polymer electrolyte, it is preferable that the polymer electrolyte is dispersed in the solvent. Here, when the catalyst material and the polymer electrolyte are dispersed in the solvent, it is preferable that the polymer electrolyte is dispersed in advance in a solvent to prepare the polymer electrolyte emulsion, and then a catalyst material is added to the polymer electrolyte emulsion to prepare the catalyst ink, in order to make the dispersion stability better. Further, the solvent can also be added after the addition of the catalyst material in order to make the dispersion stability better or to adjust the viscosity.

Moreover, an additive may be added to the catalyst ink depending on the characteristics of a desired catalyst layer. Examples of the additive include a plasticizer, a stabilizer, an adhesive adjuvant, a releasing agent, a water retaining agent, an inorganic or organic particle, a sensitizer, a leveling agent, a colorant, or the like, which are each used for common polymers. In the case of using such an additive, it is necessary to select the additive within a range not interfering with the electric reaction of the desired catalyst material of the present invention, that is, within a range not causing poisoning of the catalyst material applied. It can be confirmed by a known method such as a cyclic voltammetry method or the like whether the additive causes poisoning of the catalyst material or not.

In the preparation of the above-described polymer electrolyte emulsion and the preparation of the catalyst ink, an ultrasonic dispersion apparatus, homogenizer, ball mill, planet ball mill, a sand mill, or the like is used in terms of making the dispersion stability better.

Next, the preferable preparation method for preparing the catalyst ink of the present invention will be described.

The preparation of the catalyst ink is preferably carried out under an inert gas atmosphere, and specifically it is preferably carried out under an inert gas atmosphere having an oxygen concentration of 1% by volume or less. Particularly, when a primary alcohol is used as a solvent for the preparation of the catalyst ink, the preparation is particularly preferably carried out under an inert gas atmosphere. As the catalyst ink, a catalyst ink in which a primary alcohol is used as a solvent is conventionally known, but in the preparation thereof, when a catalyst material or the like is added into a mixing apparatus into which a solvent is preliminarily put, an addition opening of the mixing apparatus has ever been opened under an environmental atmosphere. Then, oxygen in the environmental atmosphere invades the mixing apparatus, and thus the primary alcohol or the like is changed into an organic carbonyl compound so that the content ratio of the organic carbonyl compound in the catalyst ink exceeds 0.2% by weight. In the method for preparing the catalyst ink of the present invention, in order to overcome such a problem, the contact between the solvent and the catalyst material is carried out under an inert gas atmosphere. In one example of the preparation method, mention may be made of a method in which the catalyst material and the solvent are preliminarily put into a powder addition apparatus (a hopper or the like) and a mixing apparatus, respectively, each of the atmospheres in the powder addition apparatus and the mixing apparatus is replaced with an inert gas to adjust the atmosphere of both of the apparatuses to a predetermined oxygen concentration, and then the catalyst material from the powder addition apparatus is added to the solvent in the mixing apparatus. In addition, also in the step of contacting the catalyst material with the solvent, it is preferably to ventilate an inert gas or to bubble an inert gas into a solvent. Further, when an additive or the like other than the solvent and the catalyst material is used for the catalyst ink, any one of a process in which the additive or the like is mixed in advance with the solvent in the mixing apparatus and a process in which the additive or the like is put into the same powder addition apparatus as for the catalyst material and then put into the mixing apparatus together with the catalyst material is available, but the former is preferred in terms of the more convenient operation.

In the case of an experimental operation, mention may be made of a method in which both of the raw material and the apparatus used for the preparation of the catalyst ink are put into a treatment chamber, such as a glove box, a glove bag, or the like, capable of holding an atmosphere replaced with an inert gas, the atmosphere in the treatment chamber is sufficiently replaced with an inert gas and then the catalyst ink is prepared in the treatment chamber. If such a treatment chamber is used, there is an advantage that the inside of the treatment chamber can be sufficiently replaced with an inert gas, and thus the operation becomes more convenient.

Specific examples of such an inert gas include rare gases such as nitrogen, argon, or the like. Further, the atmosphere of an inert gas preferably has oxygen sufficiently removed, and more preferably an oxygen concentration of 0.8% by volume or less, and even more preferably 0.5% by volume or less. In addition, this oxygen concentration can be measured using a zirconia sensor type concentration meter. This zirconia sensor type oxygen meter can sense an oxygen concentration with relatively low concentration. Further, the inert gas is more preferably a dry gas in which moisture is also sufficiently removed.

In order to further disperse a catalyst material in a solvent after contacting and mixing the solvent and the catalyst material, it is preferable to carry out stirring or the like by a suitable method. For stirring or the like in this case, for example, a means such as an ultrasonic dispersion apparatus, a homogenizer, a ball mill, a planet ball mill, a sand mill, or the like can be used. Further, the temperature condition when the solvent and the catalyst material are subjected to stirring or the like is preferably chosen within a range of from 25° C. to a temperature lower than the boiling point of the solvent, and preferably within a range of from 25° C. to a temperature which is 5° C. lower than the boiling point of the solvent. In addition, the time when stirring or the like is performed is selected from a range of from 1 minute to 24 hours, and preferably a range of from 10 minutes to 10 hours.

<Method for Storing Catalyst Ink>

Furthermore, for the catalyst ink prepared in the above method, it is preferable that an inert gas atmosphere is held in a series of operations of taking out or storage after the preparation. Particularly, in the case of storing the catalyst ink for a long period of time, a method for storing the catalyst ink in a treatment chamber capable of holding an atmosphere replaced with an inert gas as described above or a method for pressing and charging an inert gas into a container in which the catalyst ink is put, sealing the container, and storing are preferred. In addition, when the inert gas is charged into the container, it is necessary to determine the charged amount after taking into consideration the pressure resistance of the container.

<Method for Preparing Catalyst Layer>

Next, a method for preparing the MEA (fuel cell) using the catalyst ink of the present invention will be described.

As the method for preparing an MEA using the catalyst ink, a known method can be used. That is, any of the followings can be applied:

(1) a method in which a catalyst layer is formed directly on a polymer electrolyte membrane,

(2) a method in which a catalyst layer is formed on a substrate to be a gas diffusion layer, such as carbon paper or the like, and then the catalyst layer is assembled with a polymer electrolyte membrane, and

(3) a method in which a catalyst layer is formed on a supporting substrate, the catalyst layer is transferred to a polymer electrolyte membrane, and then the supporting substrate is peeled off.

With the use of the catalyst ink of the present invention, according to any one of those methods, a catalyst layer which is capable of inhibiting the catalyst poisoning extremely well and an MEA including the catalyst layer can be prepared.

The catalyst layer prepared using the catalyst ink of the present invention can sufficiently reduce the content of organic carbonyl compounds which cause catalyst poisoning. Specifically, it is possible to prepare the catalyst layer having the content as expressed in a weight content of the organic carbonyl compounds based on the total weight of the catalyst layer which is 1.5% by weight or less. It is even more preferable that the weight content of the organic carbonyl compounds in the catalyst layer be 1.3% by weight or less, 1.0% by weight or less, 0.8% by weight or less, 0.5% by weight or less, or 0.3% by weight or less.

The MEA, the fuel cell, and its production method relating to preferred embodiments will be described with reference to the drawing.

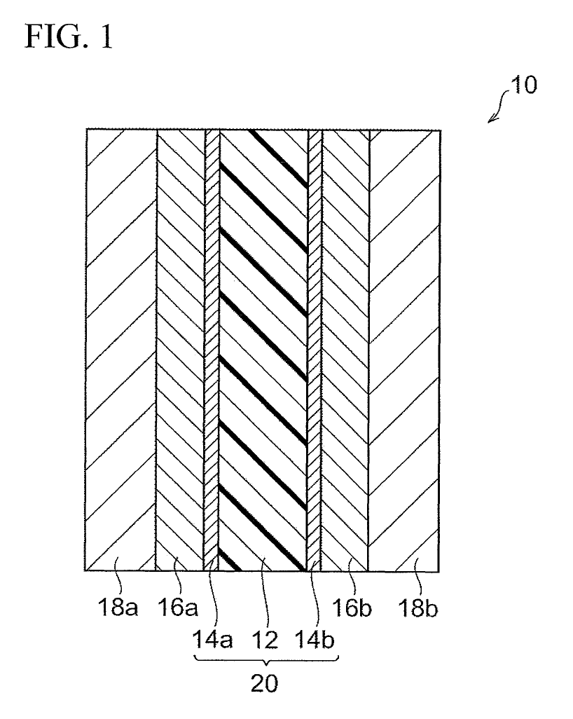

FIG. 1 is a schematic view showing the cross-sectional constitution of a fuel cell according to the preferred embodiment. As illustrated, in a fuel cell 10, on both sides of a polymer electrolyte membrane 12 (ion-conductive membrane) composed of a polymer electrolyte membrane, catalyst layers 14a and 14b, gas diffusion layers 16a and 16b, and separators 18a and 18b are formed in this order sandwiching the membrane. The polymer electrolyte membrane 12, and a pair of catalyst layers 14a and 14b sandwiching this constitute a MEA 20.

First, the polymer electrolyte membrane 12 in the fuel cell 10 will be described in detail.

The polymer electrolyte membrane 12 is obtained by molding a polymer electrolyte into a film form, and as the polymer electrolyte, any one of the polymer electrolytes having acidic groups and the polymer electrolytes having basic groups can be applied. However, as well as the preferable polymer electrolyte employed in the above-described catalyst layer, a polymer electrolyte having an acidic group is preferably used, since a fuel cell in which the electricity generation performance is much superior is obtained. The acidic group is the same as exemplified as above, among them sulfonic acid group is particularly preferred.

Specific examples of the polymer electrolyte include the polymer electrolytes of (A) to (F) as described above. Among these, a hydrocarbon polymer electrolyte is preferred in view of recyclability and cost. In addition, the “hydrocarbon polymer electrolyte” is defined as above. In terms of compatibility between high electricity generation performance and durability, in the above (C) or (E), a polymer in which the main chain of the polymer electrolyte has mainly aromatic groups linked therewith, that is, an aromatic polymer electrolyte is preferred. The acidic group of the aromatic polymer electrolyte may be directly substituted on the aromatic rings constituting the main chain or bonded via a defined linkage to the aromatic rings constituting the main chain. A combination thereof may also be available.

The aromatic polymer electrolyte is preferably soluble in the solvent. Such an aromatic polymer electrolyte soluble in the solvent can be easily formed in membrane by a known solution cast method and has an advantage in that a polymer electrolyte membrane having a desired membrane thickness can be formed.

Here, the “polymer having aromatic groups linked” is, for example, a polymer in which divalent aromatic groups are linked together to constitute the main chain as polyarylene, or a polymer in which divalent aromatic groups are linked via another divalent group to constitute the main chain. In the latter case, examples of the divalent group linked to the aromatic groups include an oxy group, a thioxy group, a carbonyl group, a sulfinyl group, a sulfonyl group, an amide group, an ester group, a carbonate ester group, an alkylene group having about 1 to 4 carbon atoms, a fluorine-substituted alkylene group having about 1 to 4 carbon atoms, an alkenylene group having about 2 to 4 carbon atoms, and an alkynylene group having about 2 to 4 carbon atoms.

Examples of the divalent aromatic groups include hydrocarbon aromatic groups such as a phenylene group, a naphthalene group, an anthracenylene group, a fluorenediyl group, or the like, and aromatic heterocyclic groups such as a pyridinediyl group, a furandiyl group, a thiophenediyl group, an imidazolyl group, an indolediyl group, a quinoxalinediyl group, or the like. Further, the divalent aromatic groups may have a substituent in addition to the above-described acidic group. Examples of the substituent include an alkyl group having 1 to 20 carbon atoms, an alkoxy group having 1 to 20 carbon atoms, an aryl group having 6 to 20 carbon atoms, an aryloxy group having 6 to 20 carbon atoms, a nitro group, a halogen atom, or the like.

As a particularly preferable aromatic polymer electrolyte, when making a polymer electrolyte membrane, one capable of providing a polymer electrolyte membrane which is phase-separated is preferred, preferably microphase-separated, having a combination of a domain having an acidic group and a domain having substantially no ion-exchange group. The former domain contributes to proton conductivity and the latter domain contributes to mechanical strength. When observed by a transmission electron microscope (TEM), for example, the microphase-separated structure as mentioned herein refers to a structure in which a fine phase (microdomain) having a higher density of a block having an acidic group than that of a block having substantially no ion-exchange group and a fine phase (microdomain) having a higher density of a block having substantially no ion-exchange group than that of a block having an acidic group co-exist, and thus the domain width (identity period) of each of the microdomain structures is several nanometers to several hundreds nanometers. As the above-described aromatic polymer electrolyte, those which can form a polymer electrolyte membrane having a microdomain structure having a domain width of from 5 nm to 100 nm are preferred.

In addition, as the aromatic polymer electrolyte which easily forms a polymer electrolyte membrane having the above-described microphase-separated structure, an aromatic polymer electrolyte which has a block having an acidic group and a block having substantially no ion-exchange groups, a copolymerization manner thereof being block copolymerization or graft copolymerization, like the polymer electrolytes of the above (C), (E), is preferred. These easily allow fine phase separation in the order of molecular chain sizes by the chemical bond of the heterogeneous polymer blocks, and as a result, a polymer electrolyte membrane having a microphase-separated structure can be well-formed. Among these, a block copolymer is preferred.

The “block having an acidic group” means a block in which the acidic group is contained at the number of 0.5 or more on average per repeating unit constituting such a block, and a block in which the acidic group is contained at the number of 1.0 or more on average per repeating unit is more preferable. On the other hand, the “block having substantially no ion-exchange groups” means a block in which the number of the ion-exchange group is less than 0.5 on average per repeating unit constituting the block, a block in which the number of the ion-exchange group is 0.1 or less on average is preferable, and a block in which the number of the ion-exchange group is 0.05 or less on average is more preferable.

Examples of the block copolymer preferable to the polymer electrolyte membrane 12 include the block copolymers as mentioned above, but the block copolymer as disclosed by the present Applicant in JP-2007-177197-A is particularly preferable since it can form a polymer electrolyte membrane which attains ion conductivity and water resistance at high levels.

The optimal range of the molecular weights of the polymer electrolyte constituting the polymer electrolyte membrane 12 is preferably appropriately set depending on its structure, but the polystyrene-equivalent number average molecular weight as determined, for example, by a GPC method is preferably from 1000 to 1000000. The molecular weight is more preferably from 5000 to 500000, and even more preferably from 10000 to 300000.

In addition, the polymer electrolyte membrane 12 may contain other components within a range that does not remarkably reduce the proton conductivity, depending on desired properties, in addition to the above-described polymer electrolytes. Examples of the other components include additives such as a plasticizer, a stabilizer, a release agent, a water retention agent, or the like, which are each added to common polymers. Further, as the polymer electrolyte membrane 12, a composite membrane composited the polymer electrolyte with a predetermined support can also be used in order to improve the mechanical strength of it. Examples of the support include fibril-shaped or porous membrane-shaped substrates.

The catalyst layers 14a and 14b adjacent to the above polymer electrolyte membrane 12 are layers which function as an electrode layer in a fuel cell, and any one of them is an anode catalyst layer and the other is a cathode catalyst layer. In the present invention, at least one of the anode catalyst layer and the cathode catalyst layer, particularly preferably both of the catalyst layers, are allowed to have the weight content of the organic carbonyl compounds in the above-described range.

The gas diffusion layers 16a and 16b are disposed so as to sandwich both sides of the MEA 20 and promote diffusion of a raw material gas into the catalyst layers 14a and 14b. These gas diffusion layers 16a and 16b are preferably constituted of a porous material having electric conductivity. Examples of the porous material include porous carbon non-woven fabric and carbon paper. Such a porous material can be used to transport the raw material gas efficiently into the catalyst layers 14a and 14b. A membrane-electrode-gas diffusion electrode assembly (MEGA) is constituted of the polymer electrolyte membrane 12, the catalyst layers 14a and 14b, and the gas diffusion layers 16a and 16b.

The separators 18a and 18b are formed of a material having electric conductivity, and examples of such a material include carbon, resin mold carbon, titanium, stainless steel, or the like. A groove, though not shown, as a flow path for supplying a fuel gas or the like to the side of the gas diffusion layers 16a and 16b, is preferably formed on the separators 18a and 18b, respectively.

Further, the fuel cell 10 may also be those in which the cell having the above-described structure is sealed by a gas seal body or the like (not shown). In addition, a plurality of the fuel cells 10 with the above structure are connected in series and then may also be subjected to practical use as a fuel cell stack. The fuel cell having such a constitution can work as a solid polymer electrolyte fuel cell in a case where fuel is hydrogen, and as a direct methanol fuel cell in a case where the fuel is a methanol aqueous solution.

By using the catalyst ink of the present invention having the reduced weight content of the organic carbonyl compound, a catalyst layer having the reduced weight content of the organic carbonyl compounds and the MEA including the catalyst layer can be obtained. In the catalyst layer having the reduced weight content of the organic carbonyl compounds and the MEA including the catalyst layer, the poisoning of the catalyst material is sufficiently inhibited, and thus the catalytic capability which the catalyst material originally has can be efficiently exerted. From this, by using the catalyst layer and the MEA, a fuel cell having excellent electricity generation characteristics can be prepared.

Next, in the catalyst layer prepared from the catalyst ink of the present invention and the MEA including the catalyst layer, a method for measuring the weight content of the organic carbonyl compounds will be described. First, the catalyst layer is mechanically separated from the MEA. In a laboratory, the catalyst layer may be spread with a spatula or the like. Then, the weight of the separated catalyst layer (hereinafter referred to as a “separated catalyst layer”) is measured. For this separated catalyst layer, a suitable solvent is used as an extraction solvent, and the extraction solvent and the separated catalyst layer contact each other by immersion or the like. The organic carbonyl compound contained in the separated catalyst layer is extracted with the extraction solvent to prepare a sample to be measured. In order to enhance the extraction efficiency, the separated catalyst layer may be made finer by grinding or the like. Further, the catalyst materials or the like which are insoluble components after extraction may be separated by solid-liquid separation or the like. For the solid-liquid separation, identification using, for example, a PTFE-made filter having a diameter of 0.45 μm is performed or separation by means of a centrifuge method is effective. Also, by the separation analysis of the obtained sample to be measured, the organic carbonyl compound is quantified. For the separation analysis, a gas chromatography method having high detection sensitivity can be preferably used. Further, in order to further improve the detection sensitivity, the sample to be measured may be suitably concentrated. In addition, the weight content of the organic carbonyl compounds in the catalyst layer is determined from the weight of the separated catalyst layer and the quantitative values of the organic carbonyl compound as determined by the separation analysis. When a plurality of the organic carbonyl compounds are detected, the sum thereof is determined.

Furthermore, in the case of determining the sum of the weight contents of the organic carbonyl compounds in each of the catalyst layers on both sides of the MEA, a series of operations relevant to the measurement of the weight content of the organic carbonyl compounds as described above may be carried out for the catalyst layers on both sides.

In addition, the method for measuring the contents of the organic carboxylic acids and the organic aldehydes in the MEA will be described. In this case, the method is more convenient in that it is not necessary to carry out an operation for separating the catalyst layer from the MEA.

That is, the total weight of the MEA provided for the measurement is measured, and then the MEA is allowed to be in contact with an extraction solvent, using a suitable solvent as the extraction solvent. Then, the organic carbonyl compound is extracted with the extraction solvent and the weight content of the organic carbonyl compounds is quantified as described above. In this case, in order to enhance the extraction efficiency, the MEA may be tailored or may be made finer by a means such as grinding or the like in advance.

Next, another method for quantifying the weight content of the organic carbonyl compounds in the MEA will be described.

The total weight of the MEA provided for measurement is measured, the MEA is then heated in a gas chromatography apparatus equipped with a headspace type sample stage die, and the organic carbonyl compound in a gas phase is generated and subjected to quantification as described above.

In such a method for measuring the weight content of the organic carbonyl compound, as for the preparation of the catalyst layer or the MEA, in the case of measuring the weight contents of the organic carbonyl compound (the organic carbonyl compound contained in the catalyst ink, the organic carbonyl compound used in the preparation of the polymer electrolyte membrane, or the like) to be used, a calibration line of such an organic carbonyl compound can be preliminarily determined so as to obtain the content of the organic carbonyl compounds in a sample to be measured easily. When the kind of the organic carbonyl compound contained in the catalyst layer is unclear, in a series of operations for extracting the organic carbonyl compound from the MEA or the catalyst layer, a plurality of extraction operations using another extraction solvent are carried out, each of the obtained sample to be measured is subjected to measurement by means of a gas chromatography method, and the organic carbonyl compound thus detected is quantified. By doing these, even though it is difficult to separate the organic carbonyl compound contained in the catalyst layer from the solvent by separation analysis, it is possible to carry out the detection and quantification of the organic carbonyl compound by the sample to be measured using another extraction solvent. Also, when the type of the organic carbonyl compound is unclear, the volatile organic compound is hardly soluble or insoluble in the extraction solvent in some cases, and accordingly, it is preferable to use at least two kinds of extraction solvents. Furthermore, as the extraction solvent, a solvent selected from water, water-tertiary alcohol, dimethylformamide (DMF), dimethyl sulfoxide (DMSO), and N-methyl-2-pyrrolidone (NMP) is preferred, and a solvent selected from DMF and NMP is more preferred.

Hereinbelow, the present invention will be described in more detail with reference to Examples, but the present invention is not intended to be limited thereto.

(Method for Measuring Oxygen Concentration)

Measurement was carried out using a zirconia sensor type oxygen meter (LC-750/PC-111, manufactured by Toray Engineering Co., Ltd.).

(Method for Measuring Weight Average Molecular Weight)

The number average molecular weight and the weight average molecular weight of the polymer electrolyte were determined by carrying out measurement by means of gel permeation chromatography (GPC) and then carrying out polystyrene equivalence. The measurement conditions for GPC are as follows.

GPC Condition

| | |
|---|---|
| Column | TSKgel GMHHR-M, manufactured by Tosoh |
| | Corporation |
| Column temperature | 40° C. |
| Mobile phase solvent | Dimethylformamide |
| | (LiBr is added to be 10 mmol/dm³) |
| Solvent flow rate | 0.5 mL/min |

(Method for Measuring Ion-Exchange Capacity)

A polymer electrolyte provided for measurement was processed into a membrane in a free acid form, and its dry weight was determined by using a halogen moisture meter having a heating temperature set at 105° C. Then, this polymer electrolyte membrane was immersed in 5 mL of a 0.1 mol/L aqueous sodium hydroxide solution, and then 50 mL of ion-exchange water was further added thereto, followed by being left to stand for 2 hours. Thereafter, calibration was carried out by adding 0.1 mol/L of hydrochloric acid to the solution having the polymer electrolyte membrane immersed therein, and a neutralization point was determined. Further, the ion-exchange capacity (unit: meq/g) of the polymer electrolyte membrane was calculated from the dry weight of the polymer electrolyte membrane and the amount of the hydrochloric acid required for the above neutralization.

(Method for Measuring Weight Content of Organic Carbonyl Compound)

To an MEA provided for measurement was added N,N-dimethyl formamide to which tetrabutylammonium hydroxide was added so as to be the concentration of 10% by weight. Next, the insoluble materials, such as catalyst materials or the like, were removed by a centrifuge-filtration method, and then measurement was carried out by means of gas chromatography (GC). Then, the detected organic carbonyl compounds were identified and each of them was then quantified by an absolute calibration line method.

The measurement conditions for GC are as follows.

GC Condition
Column: DB-WAX
Detection method: Hydrogen flame ionization method (FID)
Carrier flow rate: He, 5 mL/min

(Synthesis of Polymer Electrolyte 1)

A polymer electrolyte 1 (ion-exchange capacity=2.5 meq/g, Mw=340,000, Mn=160,000) was obtained, which was synthesized using SUMIKAEXCEL PES 5200P (manufactured by Sumitomo Chemical Co., Ltd.) with reference to Example 7 and Example 21 of WO2007/043274, and composed of a block having sulfonic acid group formed of the repeating units represented by the following formula:

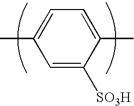

and a block having no ion-exchange groups represented by the following formula:

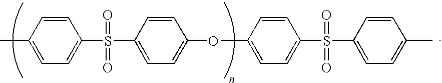

(Preparation of Polymer Electrolyte Membrane)

The polymer electrolyte 1 was dissolved in DMSO so as to be the concentration of about 10% by weight to prepare a polymer electrolyte solution. Next, this polymer electrolyte solution was added dropwise onto a glass plate. Then, using a wire coater, the polymer electrolyte solution was uniformly applied and expanded on the glass plate. Thereupon, the coating thickness was controlled using the wire coater with clearance of 0.5 mm. After coating, the polymer electrolyte solution was dried at 80° C. at normal pressure. Then, the resulting membrane was immersed in 1 mol/L hydrochloric acid, then washed with sufficient ion-exchange water, and further dried at a normal temperature to obtain a polymer electrolyte membrane with a thickness of 30 μm.

### Example 1

### Preparation of Catalyst Ink 1

First, 5% by weight of a commercially available Nafion solution (manufactured by Aldrich) was prepared. This Nafion solution was analyzed, and thus it was found that the content of 2-propanol was about 43% by weight, the content of ethanol was about 31% by weight, and the content of water was about 22% by weight. Further, the weight contents of these solvents were determined based on the total weight of the Nafion solution.

To 2.21 g of the Nafion solution was introduced 0.70 g of platinum-carried carbon (SA50BK, manufactured by N.E. Chemcat Corporation) in which 50.0% by weight platinum had been carried, and 30.56 g of ethanol which had been preliminarily subjected to nitrogen bubbling for 20 minutes and 4.52 g of water which had been preliminarily subjected to nitrogen bubbling for 20 minutes were further added thereto. The resulting mixture was subjected to an ultrasonic treatment for 1 hour and then stirred by a stirrer for 6 hours. All of the series of operations were carried out under an argon gas atmosphere. In addition, the mixture was left to stand for 17 days under an argon gas atmosphere to obtain a catalyst ink 1.

The solvent in the catalyst ink 1 was analyzed, and thus acetaldehyde, acetic acid, and propionic acid were detected as the organic carbonyl compounds. The results of determination of the weight contents thereof are shown in Table 1. Further, sample preparations in the measurement were all carried out under an argon gas atmosphere using a glove box which had been purged several times with a nitrogen gas.

### Comparative Example 1

### Preparation of Catalyst Ink 2

To 2.21 g of a commercially available 5% by weight Nafion solution (manufactured by Aldrich), which was the same as used in Example 1, was introduced 0.70 g of platinum-carried carbon (SA50BK, manufactured by N.E. Chemcat Corporation) in which 50.0% by weight platinum had been carried, and 30.56 g of ethanol and 4.52 g of water were further added thereto. The resulting mixture was subjected to an ultrasonic treatment for 1 hour and then stirred by a stirrer for 6 hours to obtain a catalyst ink 2. The preparation of the catalyst ink 2 was carried out while the mixing apparatus was opened under an air environment (oxygen concentration: about 20% by volume).

The solvent in the catalyst ink 2 was analyzed, and thus acetaldehyde, acetic acid, and propionic acid were detected as the organic carbonyl compounds. The results of determination of the weight contents thereof are shown in Table 1. Further, sample preparation in the measurement was carried out under an argon gas atmosphere using a glove box which had been purged several times with a nitrogen gas.

### Comparative Example 2

### Preparation of Catalyst Ink 3

To 2.21 g of a commercially available 5% by weight Nafion solution (manufactured by Aldrich), which was the same as used in Example 1, was introduced 0.70 g of platinum-carried carbon (SA50BK, manufactured by N.E. Chemcat Corporation) in which 50.0% by weight of platinum had been carried, and 30.56 g of ethanol and 4.52 g of water were further added thereto. The resulting mixture was subjected to an ultrasonic treatment for 1 hour, stirred by a stirrer for 6 hours, and then left to stand for 17 days to obtain a catalyst ink 3. The preparation of the catalyst ink 3 was carried out while the mixing apparatus was opened under an air environment (oxygen concentration: about 20% by volume).

The solvent in the catalyst ink 3 was analyzed, and thus acetaldehyde, acetic acid, and propionic acid were detected as the organic carbonyl compounds. The results of the determination of the weight contents thereof are shown in Table 1. Further, sample preparation in the measurement was carried out under an argon gas atmosphere using a glove box which had been purged several times with a nitrogen gas.

TABLE 1

| | Weight content (weight ppm) | | | |
|---|---|---|---|---|
| | of organic carbonyl compounds | | | |
| | | Acetic | | |
| | Acetaldehyde | acid | Propionic acid | Total |
| Example 1 | 630 | 220 | 30 | 880 |
| Comparative | 4800 | 230 | 10 | 5040 |
| Example 1 | | | | |
| Comparative | 4000 | 170 | 10 | 4180 |
| Example 2 | | | | |

The catalyst ink prepared in Example 1, or Comparative Examples 1 or 2 is applied onto the polymer electrolyte membrane 1, and dried, for example, by the method of Example 1 of JP-2008-140779-A to prepare a membrane-electrode assembly, and further sandwiched with the separators etc., thereby preparing a fuel cell. Humidified hydrogen and humidified air are supplied to the anode and the cathode, respectively while maintaining the fuel cell at 80° C. The back pressure of the gas, the water temperature of a bubbler for humidification, and the flow rates of hydrogen and air are as follows.
Back pressure: 0.1 MPaG (anode), 0.1 MPaG (cathode)
Water temperature of bubbler: 45° C. (anode), 55° C. (cathode)
Hydrogen flow rate: 529 mL/min
Air flow rate: 1665 mL/min

Further, if the current density is measured when the voltage becomes 0.4 V, a particularly higher current density in Example 1 is obtained, as compared to those in Comparative Examples 1 and 2. This may be potentially caused by the interference with the catalyst reaction of the anode or the cathode by acetaldehyde as described in Electrochimica Acta 52 (2006) 1627-1631.

### Example 2

### Preparation of Catalyst Ink 4

To 2.21 g of a commercially available 10% by weight Nation aqueous solution (manufactured by Aldrich), was introduced 0.70 g of platinum-carried carbon (SA50BK, manufactured by N.E. Chemcat Corporation) in which 50.0% by weight of platinum had been carried, and 30.56 g of t-butyl alcohol and 4.52 g of water were further added thereto. The preparation of the catalyst ink 1 was carried out under a nitrogen gas atmosphere (oxygen concentration: 0.2% by volume) using a glove box which had been purged four times with an argon gas. The resulting mixture was subjected to an ultrasonic treatment for 1 hour and then stirred by a stirrer for 6 hours to obtain a catalyst ink 4. For this catalyst ink 4, a primary alcohol to be converted to an organic carbonyl compound was not used, and accordingly, it can be mentioned that the weight content of organic carbonyl compound is substantially 0% by weight.

Subsequently, an MEA was prepared. First, the above catalyst ink 4 was applied by using a large-sized pulse spray catalyst forming apparatus (spray gun type: NCG-FC(CT), manufactured by Nordson) to a region 5.2 cm square in the middle of one surface of the polymer electrolyte membrane 1 prepared above. On this occasion, the distance from the exhaust port of the spray gun to the membrane and the stage temperature were set at 6 cm and 75° C., respectively. In the same manner, recoating was performed 8 times, the membrane was then left to stand on the stage for 15 minutes, and the solvent was removed to form an anode catalyst layer. The platinum content of the anode catalyst layer was 0.60 mg/cm² as calculated from the composition and the weight of the coating of the formed anode catalyst layer. Subsequently, the catalyst ink 4 was applied to another surface thereof in the same manner as in the anode catalyst layer to form a cathode catalyst layer having a platinum content of 0.60 mg/cm², whereby an MEA was obtained.

In the catalyst layer on one side of the MEA, the organic carbonyl compound was analyzed. The weight contents of the organic carbonyl compounds based on the total weight of the catalyst layer is shown in Table 2. Further, since the catalyst layer on the other side is also prepared in the same manner, the weight content of the organic carbonyl compounds is substantially equivalent. Since the catalyst ink 4 has no organic carbonyl compound as described earlier, it is presumed that the acetic acid contained in the catalyst layer of the MEA is incorporated from the environmental atmosphere upon preparation of the polymer electrolyte membrane 1 or the MEA. In this case, a catalyst layer capable of sufficiently maintaining the catalyst capability of the catalyst material can be formed by sufficiently reducing the weight contents of the organic carbonyl compounds in the catalyst ink.

TABLE 2

| | Weight content (weight %) of organic carbonyl compound | | | |
|---|---|---|---|---|
| | | Acetic | | |
| | Acetaldehyde | acid | Propionic acid | Total |
| Example 2 | <0.1 | 0.2 | <0.1 | <0.4 |

As described above, since a membrane-electrode assembly capable of sufficiently exerting the catalyst capability originally contained by the catalyst material can be provided by the present invention, the present invention has extremely great utility value in industry.

### INDUSTRIAL APPLICABILITY

According to the production method of the present invention, or to the catalyst ink of the present invention, a catalyst layer capable of sufficiently exhibiting the catalyst capability of a catalyst material can be prepared. Therefore, an MEA and a fuel cell, each having excellent electricity generation characteristics, can be provided. Further, it can also be expected to use a small amount of a relatively expensive catalyst material used in the catalyst layer, which is thus industrially extremely available.

1. A catalyst ink for preparing a catalyst layer of a solid polymer electrolyte fuel cell, wherein the ratio of the sum of the weights of an organic aldehyde and an organic carboxylic acid relative to the total weight of the catalyst ink is 0.20% by weight or less.

2. The catalyst ink according to claim 1 which contains water as a solvent.

3. The catalyst ink according to claim 1 which contains a primary alcohol as a solvent.

4. The catalyst ink according to claim 2, wherein the ratio of the sum of the weights of a primary alcohol and/or the water relative to the total weight of the solvent constituting the catalyst ink is 90.0% by weight or more.

5. The catalyst ink according to claim 3, wherein the primary alcohol is an alcohol having 1 to 5 carbon atoms.

6. The catalyst ink according to claim 1, wherein the organic carboxylic acid or the organic aldehyde is a compound which vaporizes under 101.3 kPa at 300° C. or lower.

7. A method for preparing the catalyst ink according to claim 1, the method comprising a step of bringing a catalyst material and a solvent into contact with each other under an inert gas atmosphere having an oxygen concentration of 1% by volume or less.

8. A method for storing the catalyst ink according to claim 1, wherein the catalyst ink is stored under an inert gas atmosphere having an oxygen concentration of 1% by volume or less.

9. A catalyst layer prepared using the catalyst ink according to claim 1.

10. A membrane-electrode assembly comprising the catalyst layer according to claim 9.

11. A solid polymer electrolyte fuel cell comprising the membrane-electrode assembly according to claim 10.
